(19) United States
(12) Patent Application Publication
(10) Pub. No.: US 2020/0324446 A1
(43) Pub. Date: Oct. 15, 2020

(54) INJECTION CONTROLLER WITH INSULATION COMPONENT MONITORING AND VERBAL ANNOUNCEMENT OF DISPENSE-RELATED INFORMATION

(71) Applicant: Building Envelope Materials LLC, Lexington, MA (US)

(72) Inventors: Douglas W. Lamm, Lexington, MA (US); Alexander C. Bell, Madbury, NH (US)

(73) Assignee: Building Envelope Materials LLC, Lexington, MA (US)

(21) Appl. No.: 16/848,094

(22) Filed: Apr. 14, 2020

Related U.S. Application Data
(60) Provisional application No. 62/833,719, filed on Apr. 14, 2019.

(51) Int. Cl. B29C 44/60

(52) U.S. Cl. CPC B29C 44/60; B29C 44/42

(57) ABSTRACT

A controller for a wall cavity insulation injection system monitors foam precursor dispensing from storage vessels, in embodiments via flow gauges and/or scales, and improves dispense volume accuracy and/or quality by providing audible, verbal information to the operator, enabling injection of high expansion foams without wall blowout. Embodiments verbally up-count or down-count elapsed time, dispensed quantities, and/or filled volumes to enable dispensing without cavity volume input. Other embodiments accept cavity volume input and down-count to a required time, quantity or volume. Bar codes, QR codes, etc. can be associated with wall cavities and/or precursor vessels and scanned to input information. Embodiments monitor precursor dispense ratios and/or precursor vessel contents, and prevent further dispensing upon detection of an error condition to avoid off-ratio dispensing and system contamination by air due to an empty precursor vessel. Embodiments verbally describe errors and suggest remedies for correction thereof. Embodiments further include visual displays.

### RELATED APPLICATIONS

This application claims the benefit of U.S. Provisional Application No. 62/833,719, filed Apr. 14, 2019. This application is also related to U.S. application Ser. No. 15/251,783 filed Aug. 30, 2016, which claims the benefit of U.S. provisional application 62/222,281 filed Sep. 23, 2015. All of these applications are herein incorporated by reference in their entirety for all purposes.

### FIELD OF THE INVENTION

The invention relates to apparatus useful for application of insulation materials, and more particularly, to apparatus useful for dispensing measured quantities of insulation materials into enclosed spaces.

### BACKGROUND OF THE INVENTION

Heating and cooling of buildings accounts for approximately 35% of all the energy consumed in the United States of America (USA). Thanks to numerous innovations in construction practices and materials used in new construction, new buildings typically use less than half the energy per square foot of older buildings. However, since most buildings last for 50 years or more, several generations will pass before the low energy consumption buildings that are currently being constructed begin to have a significant impact on the overall energy used by buildings in the USA.

Accordingly, it is often desirable to increase the thermal insulation of existing buildings. Often, insulation can be easily added above living spaces if there is an accessible attic or other space above the room ceilings. However, most walls, and most cathedral ceilings, are made up primarily of enclosed spaces bounded by inner and outer wall panels, and by beams and joists. These enclosed spaces, referred to herein generically as “wall cavities,” “ceiling cavities,” or simply as “cavities,” are not accessible, and may be poorly insulated. Of course, wall and ceiling panels can be removed, and then replaced after new insulation has been installed, but this is a highly disruptive and expensive approach that is rarely used in practice.

A more common approach is to inject insulation into the wall cavities and cathedral ceiling cavities through very small holes that are easily repaired afterward. According to this approach, small, temporary holes are made in either the interior or exterior wall panels and/or cathedral ceiling panels, and an insulating material is dispensed or “injected” into the cavities. The insulating material can be a particulate or fibrous insulating material that has good insulating properties. However, for large projects such as entire buildings a very large volume of the insulation may be required, which can be problematic and expensive to store and transport.

Another approach is to inject “foam-in-place” insulation into the cavities. According to this approach, at least one foam “precursor” is injected as a liquid or spray through the holes, whereupon the precursor undergoes a chemical reaction and is converted within the cavity into a foam that expands and fills the cavity. It should be noted that while much of the disclosure that is presented herein is directed to foam-in-place insulation, the term “precursor” is used generally herein to refer to any substance that can be injected through holes formed in a wall or ceiling panel to fill a wall or ceiling cavity with insulation. Accordingly, unless otherwise required by context, the term “precursor” as used herein also includes insulating materials that do not undergo chemical reactions within a cavity, such as fibrous or granulate insulating materials that can be injected into a cavity.

Attempts have been made to insulate wall cavities using a foam-in-place material that is formed by a single component precursor, which typically reacts with ambient moisture to create the foam. However, these single component foams have generally yielded inconsistent results, due mainly to an inability to determine and control moisture levels within the wall cavities.

Instead, two-component foams are typically used for injected foam-in-place insulation. In comparison with single component foams, two-components foams can provide more consistent results, because the two components or “precursors” of the foam can be mixed and injected in controlled amounts and with a known ratio, so that they can fully react with each other within the wall cavity to form the desired quantity of foam insulation.

Most commonly, a two-component low expansion foam, referred to herein as a “froth” foam, is used for injected insulation. Froth foams typically combine the two chemical precursor components with a gaseous blowing agent. They have the advantage that they only expand 3 to 5 times their post-dispense volume, thereby reducing the danger of overfilling of wall cavities and possible “blow-out” damage to the wall panels due to an overpressure of expanded foam.

However, the packaging, metering and mixing of froth foams is problematic and expensive. Due to the gaseous blowing agent, froth foams are transported and stored in pressure vessels that are expensive to package and ship. The reusable pressure vessels are heavy, cannot easily be moved from place to place within a building, and are exceedingly difficult for manufacturers to track. Also, it can be difficult to accurately control the dispensed volume and to ensure proper mixing of the material as it is dispensed.

Another approach is to use a “pour” foam, which is formed by mixing two liquid precursors together, sometimes also with a liquid blowing agent or with water, and which typically expands to about 30 times or more its post-dispense volume. For example, a polyurethane foam can be formed by a two-component mixture composed of isocyanate and polyol resin that are mixed near the tip of a dispensing “gun” just before injection into a wall cavity. It should be noted that the term “pour foam” is used herein generically to refer to any foam that is formed by mixing two liquid components, and that expands to at least 20 times its post-dispense volume.

Because the precursor components of pour foams are purely liquid, pour foams are relatively easy and inexpensive to package, transport, and handle. However, installation of a pour foam into existing wall and ceiling cavities requires that the dispensed quantities must be very accurately controlled and calibrated, so as to provide optimal insulation without risking overpressure and wall panel blow-out. Also, it is important that the two components of the pour foam be mixed in precisely the required ratio, because otherwise the resulting foam can suffer from odor, shrinkage, off-gassing and poor insulation performance.

These requirements for highly accurate control of fill quantities and ratios, regardless of fluctuations in ambient temperature and pressure that can cause precursor flow rates to fluctuate, and the danger of wall blow-out if this accuracy is not maintained, has limited the use of pour foams for injection insulation of wall cavities. Instead, in practice it has been much more common to use froth foams for injecting foam insulation into existing wall cavities, despite the higher cost and other disadvantages of froth foam.

At the job site, the precursors of a multi-component foam are typically stored in drums or pressure tanks, which are referred to herein generically as precursor “vessels.” In some systems, precursor material flows from the precursor vessels through hoses directly to a dispensing “gun.” In other systems, precursor material flows from the precursor vessels into a volumetric “proportioner” that controls the mixing ratio of the two precursor components, and then from the proportioner to the dispense gun.

As is described in U.S. patent application Ser. No. 15/251,783, filed on Aug. 30, 2016, incorporated herein by reference in its entirety for all purposes, the volume of insulating foam that is injected into a cavity of a wall or cathedral ceiling can be determined using a process called “in-wall metering.” According to this approach, a timed calibration “shot” of the precursors is introduced into a cavity of known volume, and the time required to exactly fill the volume with foam is determined, for example using an infra-red sensor. The “shot times” that are needed to fill other volumes are then extrapolated according to this calibration.

Based on an assumption that the flow rate of the foam precursor is constant, a simple, manually controlled shot timing device is often used to meter the amount of foam dispensed into each cavity. The operator is typically required to pre-set the “shot timer” to a different injection time for each distinct cavity volume to be injected. Depending on the nature of the building or other structure, there may be hundreds of different volumes that require injection. For that reason, shot clocks are typically mounted at a convenient location on the foam-dispensing gun. Nevertheless, this approach is tedious, and prone to errors in calculating the required shot times.

The shot timer may provide a visible display of elapsed time (counting up) or of time remaining (counting down) for a given injection. However, the visible display is often of little value, because the foam-dispensing guns are typically sometimes below, sometimes above, and sometimes to the side of the operator, so that the operator is unable to view the display of the shot clock. An alarm may sound when a pre-selected injection time is reached, but if the operator is unable to see the shot timer, and is therefore unable to anticipate the end of the shot, then there may be a reaction time delay before the injection is terminated.

Another significant problem is that the initial in-wall metering calibration often becomes invalid over time, and must be periodically repeated. In particular, the calibration can be affected by changes in ambient temperature, which can lead to changes in the viscosity of the foam precursor components, thereby affecting the material flow rates. In addition, the flow rates will tend to drop as the material that is stored in the pressure vessels is dispensed, and the pressures in the storage vessels are consequently reduced. In some cases, this problem of fluctuating vessel pressure is mitigated by connecting the storage vessels to an external, supplemental compressor or compressed gas supply that stabilizes the pressures of the dispensed materials. However, this approach adds additional cost, weight, and complication to the dispensing system.

Furthermore, even when two-component foam precursors are dispensed using a volumetric proportioner, the mixing ratio of the precursor components can be incorrect when, for instance, the operator fails to fully open a valve on one of the precursor feed lines. Often, because the foam precursors are injected into closed cavities where they cannot be directly observed, an error in the mixing ratio may go undetected until a cavity has been completely filled, and in the worst case a large portion of a structure may be filled with poor quality material before a loss of calibration is detected. This can necessitate a highly invasive and expensive remediation process, whereby walls are removed so as to remove and replace the improperly reacted foams.

In addition, significant delays and additional work often result when the contents of a precursor storage vessel are exhausted. This is because the operator may not realize that the vessel is empty until air or some other gas floods through the system. The resulting need to purge gas from the dispense lines can be time consuming, and can disrupt work flow.

What is needed therefore is an insulation precursor dispensing system that provides reliable, accurate filling of wall cavities with injected insulation, and quickly alerts an operator upon detection of an error condition, such as a loss of shot time calibration, an error in a precursor mixing ratio, or a near-empty dispensing vessel, even when it may not be convenient for the operator to directly view the dispensing system.

### SUMMARY OF THE INVENTION

The present invention is a novel control apparatus that is included in a thermal insulation precursor dispensing system, and a method of use thereof. The disclosed control system enables reliable, accurate filling of wall and ceiling cavities with injected insulation even when it may not be convenient for the operator to directly view the dispensing system. Embodiments also quickly alert an operator upon detection of an error condition, such as a loss of shot time calibration, an error in a precursor mixing ratio, and/or a near-empty dispensing vessel. Embodiments are further able to audibly, verbally provide detailed information to the operator about the error condition and, in embodiments, information as to how the error condition can be corrected. Various embodiments prevent further dispensing of precursor into wall or ceiling cavities until an error condition is corrected.

It should be noted that the terms “wall cavity” and “cavity” are used herein generically, unless otherwise required by context, to refer to any enclosed space that can advantageously be filled with thermal insulation by injection of one or more materials, referred to herein as “precursors,” into the enclosed space through an opening formed in a boundary wall of the enclosed space. It should be further noted that while much of the present disclosure is directed to foam-in-place insulation, the term “precursor” is used generically herein to refer to any substance that can be injected into a cavity as thermal insulation. Accordingly, unless otherwise required by context, the term “precursor” also includes insulating materials that do not undergo chemical reactions within a cavity, such as fibrous or granulate insulating materials that can be injected into a cavity.

Specifically, the disclosed control apparatus uses a metering device associated with each precursor vessel to quantitatively monitor the dispensing of the precursors. For example, in some two-component foam-in-place embodiments the disclosed control apparatus includes first and second flow meters that directly monitor the flow rates of the first and second precursor components as they are delivered to the proportioner or directly to the dispensing gun. In other embodiments, the metering devices are (or include) first and second scales that monitor the weights of the precursor vessels and thereby monitor the dispensing of the precursors by monitoring changes in the weights of the precursor storage vessels.

The present invention further includes an audio device, and a computing device configured to receive information from the metering devices and to cause the audio device to provide audible progress information to the user in the form of comprehensible speech. The progress information can include a simple “count” of time as it passes, and/or a count of quantities of precursor dispensed and/or equivalent volumes that have been filled with the resultant insulation. Embodiments provide sufficient improvement in dispensing accuracy to enable the practical use of pour foams instead of froth foams for pour-in-place injection insulation with consistent, accurate filling of wall cavities without danger of blow-outs.

In some embodiments, as the one or more precursors are dispensed the controller provides an audible, verbal “up-count” of the dispensing time. In embodiments calibration information that associates dispensed volumes of precursors with resultant insulation volumes is provided to software that is operable on the computing device, and an audible, verbal up-count is provided of the quantity of dispensed precursors, and/or the volume of the wall cavity that has been filled with foam. For example, the controller may provide an audible count of the elapsed seconds, of the number of pounds, kilograms, etc. of precursor that has been dispensed, and/or the number of cubic centimeters, inches, etc. that will be filled by the foam generated by the precursors that have been dispensed, The operator, who is aware of the required time or quantity for each shot, is thereby able to anticipate the end of the shot, and to terminate the shot at the precise moment when the pre-determined time or quantity has been reached. This approach can be used to avoid a need to input the volume of each cavity into the controller before beginning a shot.

In other embodiments, the controller is able to accept the volume of the wall cavity as input, and based on anticipated and/or measured precursor flow rates the controller is able to provide a verbal “down-count” or other verbal direction to the operator, such as a verbal count down to zero from the calculated shot time.

In embodiments that provide a timed up-count or down-count, if a metering device detects that a precursor flow rate has deviated from a previously calibrated value, the controller can determine that an error condition exists, and can provide an audible warning to the operator. In some embodiments, during a timed shot the controller can compensate for changes in precursor flow rates by adjusting the counting rate so that it does not precisely follow the actual elapsed time. In other embodiments, the count or other progress information is halted when an error condition is detected. Because the operator generally relies on the progress information to accurately fill the cavity, the operator is thereby forced to suspend the injection of precursors into cavities until the error condition is corrected.

Embodiments further include an indicia reader, such as a barcode or QR code scanner, and in some of these embodiments visible indicia that encode cavity volumes are printed on adhesive labels and applied to the outer surfaces of wall panels so that they can be scanned to input the cavity volumes to the controller immediately before the corresponding wall cavities are filled with foam. Similarly, information regarding the full and empty weights of a precursor vessel, and/or of the quantity of precursor that is contained in the vessel, can be encoded as one or more visible indicia that appear on the precursor vessel, so that the indicia can be scanned as an input to the controlled. It should be noted that in various embodiments the controller can accept input manually, e.g. via a keyboard, keypad, or touch screen; via a scanner; and/or acoustically via an acoustic detection device, such as a microphone, in combination with speech recognition

In embodiments, when an error condition is detected, for example when the flow rates of two precursors diverge from each other and the resulting mix ratio drifts, or when one of the precursor vessels is nearly empty, the controller of the present invention immediately alerts the operator to halt the dispensing of the precursor(s). In embodiments, the controller audibly, verbally instructs the operator as to how to adjust the system so as to correct the error, for example by telling the operator which valve to adjust, in what direction, and/or by what amount.

So as to detect when a precursor vessel is nearly empty, in embodiments the controller accepts information regarding the content volume, the capacity, and/or full and empty weights of each precursor vessel, for example when a new precursor vessel is installed, or when the system is re-initialized. The controller then monitors usage of the precursor, according to dispensing times, flow rates, and changes in precursor vessel weights, as determined by the metering devices, and alerts the operator when a storage vessel is nearly empty, so that the storage vessel can be refilled or replaced before the precursor is completely expended, thereby avoiding introduction of air into the system and any consequent need to purge the system before use of the dispensing system can be resumed.

Embodiments further include pressure sensors that monitor the pressure within each of the precursor vessels. And in various embodiments the controller is able to infer the pressure within each of the precursor vessels from measured flow rates of the precursors. The precursor vessel pressures can then be used, for example, to infer a quantity of precursor that remains in each precursor vessel. Precursor vessel pressures can also be used to detect if a hose has become detached, causing a sudden drop in pressure within a precursor vessel, and/or to detect when a precursor vessel has been refilled or a new, pre-filled precursor vessel has been installed.

In embodiments, when an error condition is detected, the controller prevents further dispensing of precursor into wall cavities by ceasing to provide progress information to the operator, e.g. by stopping the counting of the shot time, and/or ceasing to recite dispensed quantities or equivalent filled volumes. Since operators rely heavily on this audible, verbal input during injection of precursors into a cavity, ceasing to provide progress information effectively prevents further dispensing of precursor into a wall cavity.

Embodiments further include automated shut-off valves installed in the precursor delivery lines that are operated by the controller of the present invention. In embodiments, these shut-off valves are used by the controller to terminate each “shot” when it is completed, so that operator error is further reduced, and to prevent further dispensing of precursors if an error condition is detected such as a mixing ratio or empty vessel error.

In various embodiments, the controller further includes a device that is able to detect sounds, and the software of the computing device includes speech recognition, whereby in embodiments the operator is able to audibly, verbally input information into the controller, for example by verbally reciting the volume of each wall cavity before it is filled with foam. In some of these embodiments, the controller verbally repeats the information back to the operator, and waits for confirmation before proceeding, thereby avoiding speech recognition errors. Embodiments further include visible displays, such as touch screen displays, and some of these embodiments provide real time visual diagnostic information on the displays. In some embodiments, for example, the computing device is a laptop computer, tablet computer, or “smart” cellular telephone that includes a built-in visual display, as well as audio input(s) and output(s) that can used as provided or in combination with an external microphone and/or amplifying speaker. Embodiments further include wired and/or wireless network communication that can be used for remote monitoring, software updates, and/or downloading of recorded data during and/or after completion of a project. In various embodiments, the computing device is further used to store job data that can be used for job closeout documentation.

In some embodiments, all elements of the disclosed controller are located proximal to the precursor storage vessels, while in other embodiments the audio device is remote from other components of the controller, for example in circumstances where an operator might have difficulty hearing information transmitted by the controller if the audio device were located proximal to the precursor storage vessels. In some of these embodiments, the audio device is in wireless communication with the computing device, for example via wireless LAN or Bluetooth communication.

In some embodiments, the audio device is attachable to the user proximal to at least one of the operator's ears, and some of these embodiments include a microphone that is attached proximal to the operator's mouth. For example, the audio device can be a Bluetooth “ear bud” that is positioned in or over the user's ear or ears, or the audio device and microphone can be provided together as a wireless Bluetooth “headset” that is worn over the operator's ears and that positions a microphone proximal to the user's mouth, so that the operator can verbally exchange information with the controller. In various embodiments, the disclosed controller can be added as a retrofit to a conventional precursor dispensing system.

The present invention is a controller for an insulation injection system that includes a first precursor vessel. The controller includes an audio device, a first metering device configured to obtain first metered information relevant to at least one of an amount of a first precursor contained in the first precursor vessel and a rate of flow of the first precursor out of the first precursor vessel, and a computing device configured to receive the first metered information from the first metering device and to cause the audio device to emit audible operator information as comprehensible speech that is perceptible to an operator during an injection shot, said injection shot being a period of time during which the first precursor is dispensed from the first precursor vessel and injected by the operator into a cavity, at least some of said operator information being determined according to the first metered information, said operator information including progress information that enables the operator to anticipate an end of the injection shot, thereby enabling the operator to accurately dispense a desired quantity of the first precursor into the cavity.

In embodiments, the first metering device is a flow measurement device configured to measure the rate of flow of the first precursor out of the first precursor vessel, or a weight measurement device configure to measure a weight of the first precursor vessel.

In any of the above embodiments, the progress information can include at least one of a verbal count of elapsed time during the injection shot, a count of a quantity of dispensed precursor, and a count of a volume of foam that has been or will be formed within the cavity due to the dispensing shot.

In any of the above embodiments, the computing device can be configured to accept the desired quantity as an input or to determine the desired quantity according to at least one quantity-related input, and to monitor the dispensing of the first precursor during the injection shot, and the progress information can include information that informs the operator of a relative degree of completion of the injection shot. In some of these embodiments, the computing device is configured to accept, as a quantity-related input, cavity volume information relating to a volume of the cavity to be filled with foam, and calculate the desired quantity of the first precursor according to the cavity volume information. In some of these embodiments the computing device is configured to accept the desired quantity of the first precursor as an input or determine the desired quantity of the first precursor according to at least one quantity-related input, the controller further comprises a flow valve associated with the first precursor vessel, and the controller is further configured to close the flow valve and thereby halt the dispensing of the first precursor when the desired quantity of the first precursor has been dispensed.

In any of the above embodiments, the insulation injection system can further comprise a second precursor vessel configured to dispense a second precursor which, upon mixing with the first precursor, reacts with the first precursor to form an insulating foam within the cavity, and the controller can further comprise a second metering device configured to obtain second metered information relevant to at least one of an amount of the second precursor contained in the second precursor vessel and a rate of flow of the second precursor out of the second precursor vessel, where the computing device is configured to determine a dispensing ratio of the first and second precursors, said dispensing ratio being a ratio of relative amounts in which the first and second precursors are being mixed by the insulation injection system to form the foam insulation; and the controller is configured to detect an error condition if the dispensing ratio deviates by more than a specified ratio deviation from a desired dispensing ratio.

In any of the above embodiments, the computing device can be configured to estimate a remaining amount of the first precursor contained in the precursor vessel, and to cause the audio device to emit audible information regarding the remaining amount of the first precursor contained in the precursor vessel as comprehensible speech that is perceptible to the operator. In some of these embodiments, the computing device is configured to determine that an error condition exists if the estimated remaining amount of the first precursor contained in the first precursor vessel is less than a determined minimum first precursor vessel quantity. In any of these embodiments, the controller can be configured to accept quantity information relevant to the first precursor vessel, and estimate the remaining amount of the first precursor contained in the first precursor vessel according to the first metered information and the quantity information. In any of these embodiments, the controller can be configured to determine a rate of flow of the first precursor out of the first precursor vessel according to the first metered information, estimate a pressure within the first precursor vessel according to the determined rate of flow of the first precursor out of the first precursor vessel, and estimate the remaining amount of the first precursor contained in the first precursor vessel according to the estimated pressure within the first precursor vessel.

In any of the above embodiments, upon determining that an error condition exists, the controller can be configured to alert the operator that the error condition exists, provide to the operator audible error information as comprehensible speech that provides information to the operator regarding the error condition, and cease emitting the progress information. In some of these embodiments, the error information includes information relevant to correcting the error condition.

In any of the above embodiments, the controller can further comprise a scanning device configured to scan visible indicia. In some of these embodiments, the computing device is configured to receive from the scanner information encoded by the visible indicia relevant to at least one of cavity volume information relating to a volume of the cavity to be filled with insulation, a quantity of the first precursor that is contained within the first precursor vessel, a weight of the first precursor vessel and a quantity of the first precursor that is contained within the first precursor vessel when the first precursor vessel is filled with the first precursor, and a weight of the first precursor vessel when the precursor vessel is empty of the first precursor.

In any of the above embodiments, the controller can further comprise an audio detection device, and wherein the computing device is configured to accept audible, verbal information from the operator.

Any of the above embodiments can further include a visual display configured to present visible information relevant to the dispensing of the precursor from the precursor vessel.

In any of the above embodiments, the audio device can be remote from the computing device, and can be in wireless communication with the computing device. And in some of these embodiments the audio device is configured for attachment to a head of the operator proximal to at least one ear of the operator.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a simplified illustration of the components included in an embodiment of the present invention;

FIG. 1B is an illustration of a computing device that includes a speaker and a display panel in a first embodiment of the present invention;

FIG. 2 is an illustration of a display panel included in a second embodiment of the present invention; and

FIG. 3 is a block diagram that illustrates relationships between components of an embodiment of the present invention.

### DETAILED DESCRIPTION

The present invention is a novel control apparatus that is included in an insulation dispensing system, and a method of use thereof. The disclosed control system is able to improve the accuracy of dispensed precursor quantities, and in embodiments also of dispense ratios, during injection of foam into wall cavities, even when it may not be convenient for the operator to directly view the dispensing system. Embodiments are further able to detect an error condition such as a loss of shot time calibration, a mixing ratio error, and/or a near-empty condition of a precursor storage vessel, and are further able to verbally alert an operator via audible, comprehensible speech regarding the error condition, and to provide detailed information about the error condition and how it should be corrected. Embodiments prevent further dispensing of precursor into wall cavities until the error condition is corrected.

Embodiments provide sufficient improvement in dispensing accuracy to enable the practical use of pour foams instead of froth foams as foam-in-place injected insulation with consistent, accurate filling of wall cavities without danger of wall blow-outs.

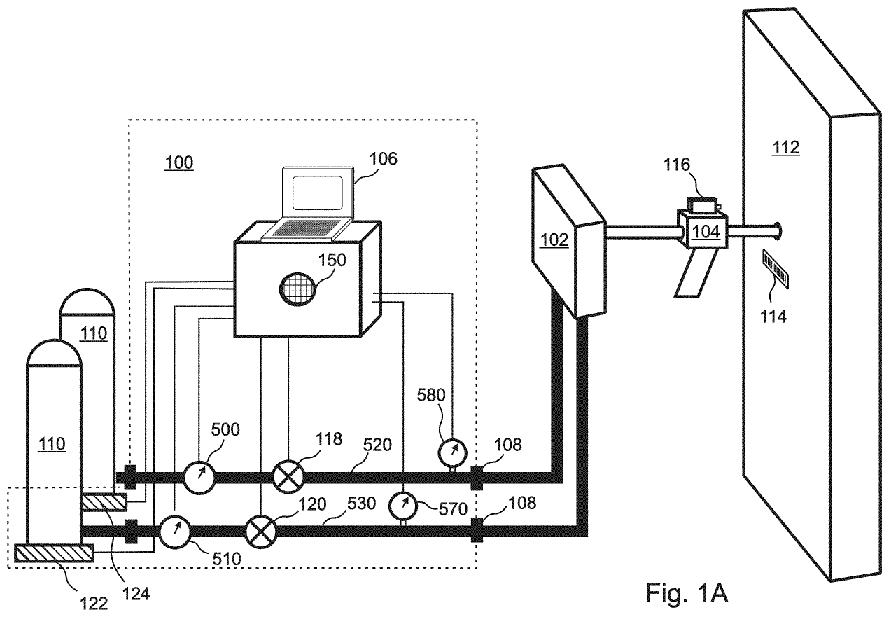

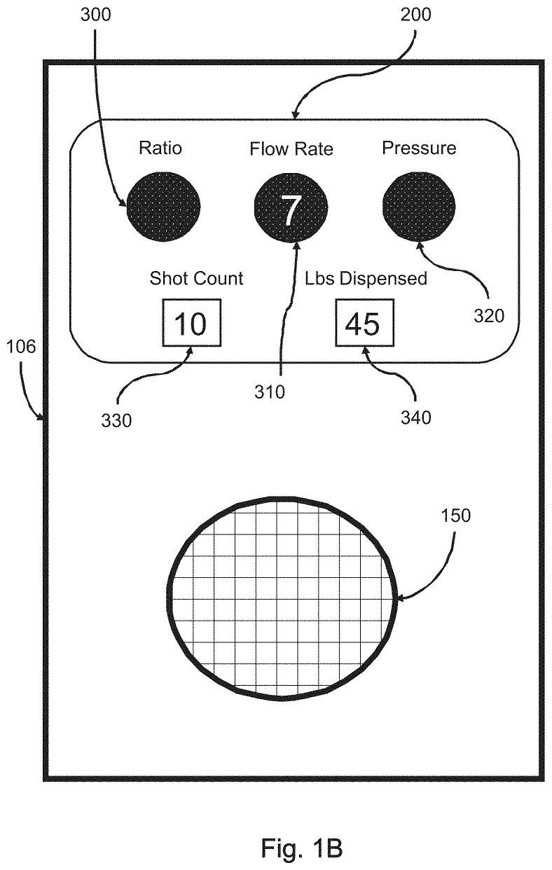

With reference to FIG. 1A, the controller 100 of the present invention associates a metering device, such as a flow valve 500, 510 and/or a scale 122, 124, with each precursor storage vessel 110, where the metering devices are configured to determine a flow rate of the associated precursor as it is dispensed, and/or a weight of the remaining contents of each vessel. For example, in the two-component embodiment of FIG. 1A, the disclosed control apparatus 100 includes first and second flow meters 500, 510 that respectively monitor flow rates of the first and second precursor components as they are delivered to the proportioner 102, or in similar embodiments directly to the dispensing gun 104 of the dispensing system. The metering devices of the illustrated embodiment further include first and second scales 122, 124 that monitor the weights of the precursor vessels 110, and thereby monitor the amount of precursor that remains in each storage vessel 110. In some embodiments, for example if flow gauges 500, 510 are not included, the scales 122, 124 are used to determine the rates at which the precursors are dispensed by monitoring changes in the weights of the precursor storage vessels.

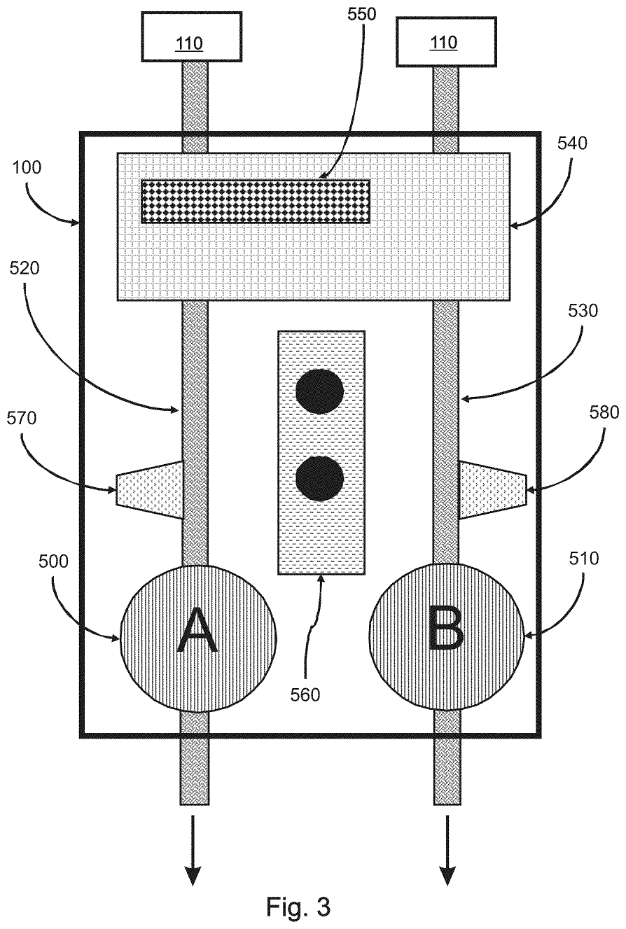

The present invention further includes an audio device 150, and a computing device 106 configured to receive information from the metering device(s) 500, 510 and to cause the audio device 150 to provide audible information to the user in the form of comprehensible speech. The computing device 106 can be a laptop, tablet computer, or “smart” cellular telephone with display. The audio device 150 can be a speaker, an ear-insertable device, or any other device that is able to emit audible sound, and can be independent of the operator or configured for attachment to the operator proximal to at least one of the operator's ears. The controller 100 further include hoses 520, 530 and fittings 108, and with reference to FIG. 3 can include a separate circuit board 540, microcontroller 550, and/or amplifier 560.

Depending on the embodiment, all functional components of the disclosed controller 100 can be housed together, as shown in FIG. 1A, or elements such as the audio device 150 can be separated. The components of the controller 100 can be housed together, as shown in FIG. 1A, for example when the precursor material storage vessels 110 are located within hearing distance of the operator when the operator is dispensing the precursor(s) into a wall cavity 112. When the precursor storage vessels 110 are located beyond the hearing distance of the operator, components the audio device 150, and in some embodiments other components such as the computing device 106, can be moved to a location remote from the other components that is proximal to the operator. Depending on the embodiment, other components of the disclosed controller 100, such as the circuit board 540 (if included) and amplifier 560, can communicate with the audio device 150 and any other remote components such as the computing device 106 via a wired or wireless connection, such as via a wireless LAN or Bluetooth.

According to a typical embodiment, as precursor material is being injected into a wall cavity 112, it flows from the precursor storage vessel(s) 110 through the hoses 520, 530 and fittings 108, through the flow meters 500 and 510 (if present), and out to the proportioner 102, or directly to the dispense gun 104. The flowmeters 500 and 510 and/or scales 122, 124 provide metering information to the computing device 106, which can be configured to control a microcontroller 550 and circuit board 540.

Once the metering information has been processed, the computing device 106 forwards operator information as audible speech to the audio device 150, which can include an amplifier 560 and speaker 150, for output to the operator, and in embodiments also to a display such as the display of a tablet computer 106, for visual output. Depending on the embodiment, the audible, verbal information can include a count-up or count-down, according to elapsed time, dispensed quantities, and/or volume filled, while the metering information is used to ensure that the flow rates, and in embodiments the precursor ratio, have not drifted. Amounts of precursor that have been disbursed, and/or the equivalent amount of volume that has been filled, can be determined from the metering data provided by the metering devices 500, 510, 122, 124. Information can also be stored by the computing device 106 for subsequent reporting and processing.

Accordingly, metering data from the metering devices 500 and 510, 122, 124 is processed by the computing device 106, which uses the audio output device 150 to provide accurate, essential, real time data to the operator as audible speech with virtually no delay.

A major risk when injecting foam precursors into a wall cavity 112 in a building is that the operator might accidentally overfill the cavity 112 and cause a “blows out” of the wall. So as to avoid this risk, in embodiments the audio device 150 is used to audibly “count out” the volume of material that has been dispensed. If data regarding the fill volume of a wall cavity has previously been input to the computing device 106, the audio device 560, 150 can verbally “tell” the operator to stop the dispensing when the appropriate amount of material has been injected or sprayed into the wall cavity.

Depending on the embodiment, this audible counting can be in standard units, such as grams, or any units that are appropriate for the wall cavity volume. For instance, if in a certain embodiment each count represents 10 grams and the audio device 560, 150 counts out “1, 2, 3, 4”, then 40 grams of material will have been dispensed.

Cavities 112 of different widths and/or volumes that are present in the same structure will require different volumes of precursor, and hence different “shot counts.” For example, a 2″ wide cavity will have half the volume, and will require half the shot count, of a 4″ wide cavity (assuming that the other cavity dimensions are equal). Entering new shot counts for every wall cavity can be time consuming and distracting for the operator. One way to avoid this is for the controller 100 to count up rather than down e.g. to audibly recite “1, 2, 3, 4, 5” rather than “5, 4, 3, 2, 1.”

Another approach is to place an adhesive label 114 on the outer surface of each wall cavity 112 on which the volume of that cavity is displayed as a scannable symbol, such as numbers presented in E13B font, a barcode, or a QR code. When precursor is to be injected into a wall cavity, a scanner 116, which can be attached to the dispense gun 104, can then be used to read the information on the label 114 attached to that wall panel 112, which can be transmitted to the computing device 106. The audio device 560, 150 can then count up or down according to the cavity volume as specified by the scanned symbol 114.

In embodiments, the controller further includes automatic control valves 118, 120, and the computing device 106 can send a signal to the automatic control valves 118, 120 that will stop the flow of foam precursor(s) when the specified volume of precursor has been dispensed, or when an error condition is detected.

Off-ratio material, i.e. precursors that are dispensed in an incorrect ratio, is another major risk when injecting foam precursors into a wall cavity 112. If the wall cavities of a building or valuable structure have been filled with off-ratio material, resulting odors and off-gassing can require that the contractor remove all of the dispensed foam material, which can be a time consuming and exceedingly expensive procedure.

In order to avoid dispensing off-ratio materials, or at least to halt the dispensing before it becomes an expensive problem, in embodiments the computing device 106 compares the flow rates of the precursors as determined by the metering devices 118, 120, 122, 124 and calculates the dispense ratio, thereby monitoring the dispensed precursor ratio in real or near-real time. For example, in the case of a two-component foam that combines precursor “A” with precursor “B,” in embodiments the A flow rate, as measured for example by a side-A flowmeter 500, is compared to the B flow rate, as measured for example by a side-B flowmeter 510. Software executed by the computing device 106 then processes the data to determine if the precursors are being dispensed in the require ratio. In other embodiments, the dispensing ratio is determined at specified intervals, for example by comparing the average amounts of dispensed precursors over a plurality of dispense shots. In embodiments, the controller 100 can provide audible, verbal updates to the operator. For example, if the material is on-ratio, the audio device 150 might output the audible words “On-ratio”.

If the precursors are not being dispensed in the required ratio, embodiments issue an audible, verbal alert indicating that dispensing should cease. So as to ensure that the operator does not continue to inject off-ratio material into wall cavities, embodiments enter a “ratio control” mode, wherein the system becomes usable only for corrective actions, but not for wall cavity injection. For instance, in embodiments the counting function of the computing device 106 is disabled, so that the dispensing system can only be used for corrective action, but not for injection.

Embodiments further provide audible, verbal instructions to the operator indicating how the problem can be corrected. The exact instructions will depend on the dispensing system's mechanism for controlling flow rates. For example, in a dispensing system that controls flow rates with manually operated valves, if the material is somewhat off-ratio, the audio device 150 might output “B side slightly too high, turn the B side control valve down 1 unit”. Or similarly, in a dispensing system that uses pressures to control precursor flow rates, the output of the audio device might be “A side much too high, turn the A side pressure down 30 psi.”

Another potential problem that can occur when filling wall cavities with foam is that a storage vessel 110 can run out of precursor while the precursor is being injected. These “material-out” conditions can disrupt work flow, and can also cause air to be injected into downstream hoses 520, 530 and possibly other apparatus 102, 104, so that the downstream hoses 520, 530 and other apparatus 102, 104 must be purged of all air before work can resume. Purging air from a long hose such as a 300-foot hose is very time consuming, and can generate hazardous aerosolized particulates. Furthermore, in a multi-precursor system if one precursor runs out before another, off-ratio material may be injected or sprayed into a wall cavity 112.

Accordingly, in embodiments the controller 100 of the present invention avoids material-out conditions by using metering data from the flowmeters 500 and 510 together with total dispensing times to calculate the total volume or weight of precursor that has been dispensed from each storage vessel 110 since the storage vessel 110 was last re-filled or exchanged. In similar embodiments, scales 122, 124 are used to determine the amount of remaining precursor. In still other embodiments, the pressure with each of the precursor vessels 110 is measured using a gauge 570, 580, or the flow rate of each precursor is used to infer the pressure within each precursor vessel 110, and the remaining quantity of precursor within each precursor vessel 110 is then estimated from the pressure. This approach can be applicable when the precursor vessels 110 are not pressurized by an external source, so that the pressure within each precursor vessel 110 drops in a predictable manner as the contents are dispensed.

According to the embodiment, a verbal warning can be given to the operator when a precursor vessel 110 is about to become empty. Embodiments cease to provide progress information when a precursor vessel 110 is nearly empty, which effectively prevents the operator from continuing to dispense precursor because the operator relies upon the progress information to ensure that the desired quantities of precursor are accurately dispensed.

Depending on the embodiment, information regarding the status of the precursor storage vessels 110 can be provided to the computing device 106 manually, or determined by the controller 100 automatically. In some embodiments that do not include scales 122, 124 as metering devices, the controller 100 will prompt the operator to enter the current weight of each storage vessel 110 whenever a certain number of minutes of non-use has elapsed, and/or whenever the controller 100 has been turned off and back on again. For example, after 10 minutes of non-use the controller 100 can prompt the user with options indicating “no change” or “new tank.” If the answer is “no change,” the controller 100 will use the last known estimate of the storage vessel contents. If the answer is “new tank,” the system will prompt the user to enter the “new tank weight” (i.e. weight of the precursor contained in the newly installed storage vessel 110). Since operators can sometimes forget to reset tank weights, embodiments will refuse to “count” and/or will otherwise prevent dispensing of the precursors until the required “new tank” information has been provided.

Other embodiments perform an automatic reset of the precursor storage vessel weight, for example using data from pressure sensors 570 and 580 and/or from another electronic circuit. For example, in embodiments if a pressure sensor 570, 580 detects a significant increase in pressure in a storage vessel 110 or in a hose 520 that is connected to a storage vessel 110, the controller 100 can automatically determine that a new storage vessel 110 having a high pressure has been installed. In other embodiments, sensors are used to detect disconnection of the precursor supply hoses 520, 530, whereupon the controller determines that a new or refilled storage vessel 110 has been installed. In embodiments that include scales 122, 124 configured for measuring the weights of the storage vessels 110, direct measurement of the weights, in combination with known empty weights of the storage vessels 110, can be used by the controller 106 to determine whether a new vessel 110 has been installed, and generally to determine how much precursor is currently within each of the vessels 110.

In embodiments the pressure within a precursor vessel 110 will decrease in a known way as precursor is dispensed from the vessel 110. Accordingly, embodiments utilize precursor vessel pressures to infer the quantity of precursor that is contained within each precursor vessel 110. This can be helpful, for example, when the computing device 106 has been reset and does not have a complete history of precursor dispensing times and rates since a precursor vessel 110 was last refilled or replaced. Precursor vessel pressures are directly measured in some embodiments by pressure gauges 570, 580. In other embodiments, because precursor flow rates can be directly related to the precursor vessel pressures, the computing device 106 is able to infer the precursor vessel pressures from measured or calculated precursor flow rates, and on that basis the computing device 106 is further able to estimate the amounts of precursor that are contained within each of the precursor vessels 110.

In various embodiments, when the computing device 106 determines that the storage vessel 110 is nearly empty, the audio device 560, 150 will provide an audible, verbal warning to the operator so that the operator can plan accordingly. For instance, the audio device 560, 150 can output a message such as “50 pounds dispensed, 30 pounds remaining” or “approximately 10 cavities remaining.”

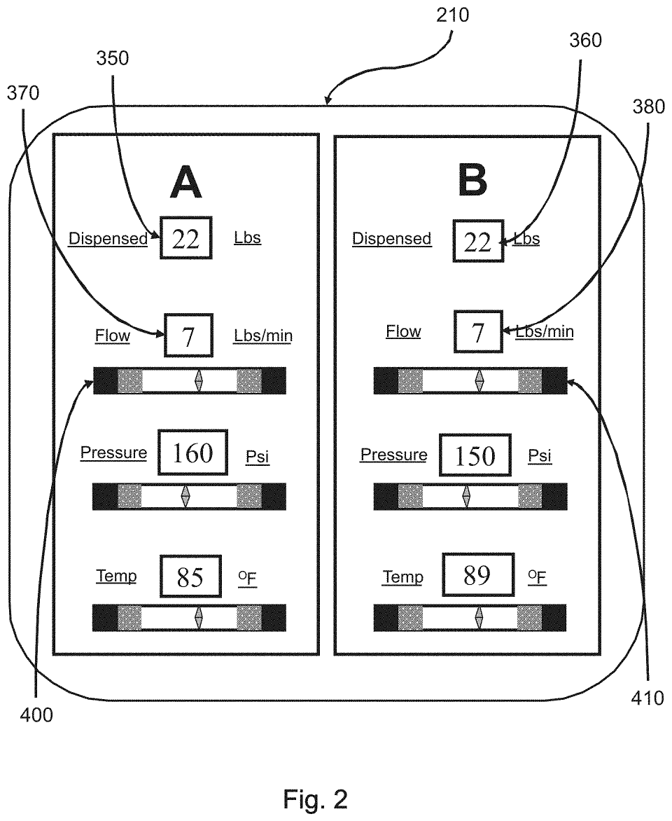

With reference to FIGS. 1B and 2, in addition to audible, verbal output to the operator, embodiments also provide output from the computing device 106 on a visible screen 200, 210 such as a tablet computer/display home screen 210. This can include a visual indication that a precursor storage vessel is almost empty, such as a tank volume indicator 340 that flashes yellow and then red as the final quantity of precursor is expended from the storage vessel 110.

Although the operator is usually busy looking at the wall cavity 112 that is being filled with foam, an assistant may be viewing the screen 210 of the computing device to monitor for any issues as precursor is dispensed. The display screen 210 in the illustrated embodiment of FIG. 3 uses colored status lights 300, 310, and 320 to provide an “at a glance” indication of “health status.” In particular, in the illustrated embodiment the status lights 300, 310 and 320 are green when all systems are working well, yellow when there is a potential problem, and red when there is a confirmed problem. For example, the colored ratio status light 300 could be green if the ratio in which the precursors are being dispensed is well within the manufacturer's tolerance specifications, yellow when the dispensing ratio is in a borderline region, and red when an off-ratio condition exists. The visual status indicators 300, 310 and 320 can also provide numeric information. For example, a flow rate status indicator 310 can display a “7” to indicate that the flow rate of a precursor is 7 grams/second.

The display screen 200 in the illustrated embodiment of FIG. 1B includes a shot count indicator 330 and tank volume indicator 340. The shot count indicator 330 provides visual information that duplicates the audibly provided shot count. To further protect against potential wall cavity overfill and blow-out, the shot count indicator 330 flashes red in the illustrated embodiment if the shot time is too long.

The screen 210 in the illustrated embodiment of FIG. 2 provides “shot count” information in terms of dispensed quantities of precursor 350, 360, as well as additional diagnostic information beyond what is provided by the display screen of FIG. 1B. Quantities of dispensed pounds of precursor 350, 360, precursor flow rates 370, 380, and precursor storage vessel pressures and temperatures are indicated separately for the A side and B side of a two-component system in the illustrated embodiment. Providing this information separately for each of the two precursor flow streams can provide additional helpful diagnostic information to the operator. For example, if the flow rate status light 300 on the tablet computer/display home screen 200 is indicating that the precursors are being dispensed off ratio, and if the A side flow rate 370 is indicating an unusual flow rate of 1 lb/min while the B side flow rate 380 is indicating a normal flow rate of 8 lbs/min, the operator will immediately know that it is the A side that requires maintenance and/or adjustment. Bar indicators as illustrated by items 400 and 410 provide a pseudo-analog indication in the illustrated embodiment of the current values of flow rate, pressure, and temperature in relation to an overall range. In general, bar indicators can provide to operators a quick “at a glance” understanding of the current status of the system.

In the embodiment of FIG. 3, flow rate data from flowmeters 500 and 510 is processed through a microcontroller 540 and stored in a computing device 106. In similar embodiments, dispensed quantities of precursor are determined using scales 122, 124 that monitor the weights of the precursor vessels 110. This data can be later processed to provide job close out and validation data, for example to a building owner and/or to a manager of injection jobs. Information from the computing device 106 can be saved either on a removable memory device, such as a thumb drive, and physically transferred to another computer, data can be transferred directly to another computer via a wireless link, or data can be wirelessly transmitted to a cloud-based storage device. The types of information that can be communicated to building owners from stored data can include:
Validation that that material injected into the building was on-ratio.
Estimated increased insulation value of material added to building cavities
Estimated energy savings from added insulation

The types of information communicated to managers from stored data can include:
Actual vs estimated pounds of precursor used
Cost of material dispensed
Actual vs estimated labor hours
Cost of labor
Average injection time per cavity or square foot per day
Average thickness of material dispensed
Precursor ratio drift and corrective actions taken
Material temperature and viscosity

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the invention is not limited to just these forms, but is amenable to various changes and modifications without departing from the spirit thereof. The disclosure presented herein does not explicitly disclose all possible combinations of features that fall within the scope of the invention. The features disclosed herein for the various embodiments can generally be interchanged and combined into any combinations that are not self-contradictory without departing from the scope of the invention. In particular, the limitations presented in dependent claims below can be combined with their corresponding independent claims in any number and in any order without departing from the scope of this disclosure, unless the dependent claims are logically incompatible with each other.

I claim:

1. A controller for an insulation injection system comprising a first precursor vessel, the controller comprising:
an audio device;
a first metering device configured to obtain first metered information relevant to at least one of an amount of a first precursor contained in the first precursor vessel and a rate of flow of the first precursor out of the first precursor vessel; and
a computing device configured to receive the first metered information from the first metering device and to cause the audio device to emit audible operator information as comprehensible speech that is perceptible to an operator during an injection shot, said injection shot being a period of time during which the first precursor is dispensed from the first precursor vessel and injected by the operator into a cavity, at least some of said operator information being determined according to the first metered information, said operator information including progress information that enables the operator to anticipate an end of the injection shot, thereby enabling the operator to accurately dispense a desired quantity of the first precursor into the cavity.

2. The controller of claim 1, wherein the first metering device is a flow measurement device configured to measure the rate of flow of the first precursor out of the first precursor vessel.

3. The controller of claim 1, wherein the first metering device is a weight measurement device configured to measure a weight of the first precursor vessel.

4. The controller of claim 1, wherein the progress information includes at least one of a verbal count of elapsed time during the injection shot, a count of a quantity of dispensed precursor, and a count of a volume of foam that has been or will be formed within the cavity due to the dispensing shot.

5. The controller of claim 1, wherein:
the computing device is configured to accept the desired quantity as an input or to determine the desired quantity according to at least one quantity-related input, and to monitor the dispensing of the first precursor during the injection shot; and
the progress information includes information that informs the operator of a relative degree of completion of the injection shot.

6. The controller of claim 5, wherein the computing device is configured to:
accept, as a quantity-related input, cavity volume information relating to a volume of the cavity to be filled with foam; and
calculate the desired quantity of the first precursor according to the cavity volume information.

7. The controller of claim 6, wherein:
the computing device is configured to accept the desired quantity of the first precursor as an input or determine the desired quantity of the first precursor according to at least one quantity-related input;
the controller further comprises a flow valve associated with the first precursor vessel; and
the controller is further configured to close the flow valve and thereby halt the dispensing of the first precursor when the desired quantity of the first precursor has been dispensed.

8. The controller of claim 1, wherein:
the insulation injection system further comprises a second precursor vessel configured to dispense a second precursor which, upon mixing with the first precursor, reacts with the first precursor to form an insulating foam within the cavity; and
the controller further comprises a second metering device configured to obtain second metered information relevant to at least one of an amount of the second precursor contained in the second precursor vessel and a rate of flow of the second precursor out of the second precursor vessel;
the computing device is configured to determine a dispensing ratio of the first and second precursors, said dispensing ratio being a ratio of relative amounts in which the first and second precursors are being mixed by the insulation injection system to form the foam insulation; and the controller is configured to detect an error condition if the dispensing ratio deviates by more than a specified ratio deviation from a desired dispensing ratio.

9. The controller of claim 1, wherein the computing device is configured to:
estimate a remaining amount of the first precursor contained in the precursor vessel; and
cause the audio device to emit audible information regarding the remaining amount of the first precursor contained in the precursor vessel as comprehensible speech that is perceptible to the operator.

10. The controller of claim 9, wherein the computing device is configured to determine that an error condition exists if the estimated remaining amount of the first precursor contained in the first precursor vessel is less than a determined minimum first precursor vessel quantity.

11. The controller of claim 9, wherein the controller is configured to:
accept quantity information relevant to the first precursor vessel; and
estimate the remaining amount of the first precursor contained in the first precursor vessel according to the first metered information and the quantity information.

12. The controller of claim 9, wherein the controller is configured to:
determine a rate of flow of the first precursor out of the first precursor vessel according to the first metered information;
estimate a pressure within the first precursor vessel according to the determined rate of flow of the first precursor out of the first precursor vessel; and
estimate the remaining amount of the first precursor contained in the first precursor vessel according to the estimated pressure within the first precursor vessel.

13. The controller of claim 1, wherein upon determining that an error condition exists, the controller is configured to:
alert the operator that the error condition exists;
provide to the operator audible error information as comprehensible speech that provides information to the operator regarding the error condition; and
cease emitting the progress information.

14. The controller of claim 13, wherein the error information includes information relevant to correcting the error condition.

15. The controller of claim 1, wherein the controller further comprises a scanning device configured to scan visible indicia.

16. The controller of claim 15, wherein the computing device is configured to receive from the scanner information encoded by the visible indicia relevant to at least one of:
cavity volume information relating to a volume of the cavity to be filled with insulation;
a quantity of the first precursor that is contained within the first precursor vessel;
a weight of the first precursor vessel and a quantity of the first precursor that is contained within the first precursor vessel when the first precursor vessel is filled with the first precursor; and
a weight of the first precursor vessel when the precursor vessel is empty of the first precursor.

17. The controller of claim 1, wherein the controller further comprises an audio detection device, and wherein the computing device is configured to accept audible, verbal information from the operator.

18. The controller of claim 1, further comprising a visual display configured to present visible information relevant to the dispensing of the precursor from the precursor vessel.

19. The controller of claim 1, wherein the audio device is remote from the computing device, and is in wireless communication with the computing device.

20. The controller of claim 19, wherein the audio device is configured for attachment to a head of the operator proximal to at least one ear of the operator.
